(19) United States
(12) Patent Application Publication
(10) Pub. No.: US 2004/0258801 A1
(43) Pub. Date: Dec. 23, 2004

(54) Vitamin fortification of foodstuffs

(76) Inventors: Alvin Ling, Houston, TX (US); Alan Wyland, Altamonte Springs, FL (US); Karen Williams, Winger Garden, FL (US)

Correspondence Address: FINNEGAN, HENDERSON, FARABOW, GARRETT & DUNNER, LLP, 1300 I STREET, NW, WASHINGTON, DC, 20005, US

(21) Appl. No.: 10/491,103

(22) PCT Filed: Sep. 26, 2002
(86) PCT No.: PCT/US02/30516

Related U.S. Application Data
(60) Provisional application No. 60/324,909, filed on Sep. 27, 2001.

(51) Int. Cl. A23L 1/30

(52) U.S. Cl. 426/72

(57) ABSTRACT

The disclosure relates to a process and composition for determining the quantity of a vitamin added to a foodstuff such as a beverage. The process involves (a) combining a predetermined amount of a chemical marker with a composition which is a carrier in combination with a predetermined amount of a vitamin to obtain a vitamin composition; (b) adding the vitamin composition to a foodstuff to obtain a vitamin fortified beverage; (c) quantitatively determining the amount of the chemical marker in the vitamin fortified foodstuff; and (d) correlating the quantitatively determined amount of the chemical marker in the vitamin fortified foodstuff with the predetermined amount of vitamin in the vitamin composition.

### BACKGROUND OF THE INVENTION

1. Field of the Invention

This application claims the benefit of Provisional Application 60/324,909, filed Sep. 27, 2001.

The invention relates to fortification of foodstuffs with vitamins, such as oil soluble vitamins A, D, E, and K, and the B vitamins, such as niacin, niacinamide, vitamin B₁, B₂, and B₆, for human or veterinary use, particularly vitamin D fortification of beverages or solid food stuffs. Typical beverages include water or fruit and vegetable juices and drinks, sports beverages, beverages employed to restore electrolytes lost through diarrhea, carbonated beverages such as seltzer waters, soft drinks or mineral drinks, milk obtained from cows or synthetic milk or so-called “botanical flavor” drinks such as cola and other natural flavored drinks.

2. Description of the Related Art

Chen et al., U.S. Pat. No. 6,162,474 describe vitamin powders for addition to beverages and a method of making such powders, which consist of droplets of a fat soluble vitamin dispersed in a modified polysaccharide matrix.

Heckert et al., U.S. Pat. No. 5,516,535 describe a beverage composition having enhanced vitamin A bioavailability, which also includes calcium, a sweetener and a flavorant. The beverage contains gums or thickeners and is free of iron or other metals, which cause vitamin degradation.

Chandler et al., U.S. Pat. No. 5,609,897 describe a powdered beverage concentrate containing a source of calcium, vitamin D, stabilizing gums such as gum arabic and a vegetable oil whereas DeWille et al., U.S. Pat. No. 5,817,351 disclose liquid beverages for supplementing dietary calcium using calcium glycerophosphate as the source of calcium, optionally in combination with vitamin D. Kirk, U.S. Pat. No. 4,966,779 describes a stable water-miscible emulsion containing a fat-soluble vitamin such as vitamin D, an edible vegetable oil, lecithin, a sucrose ester, sorbitan monooleate, a sugar alcohol and water. Langer et al., U.S. Pat. No. 4,737,367 disclose a fruit-flavored beverage containing orange juice, pineapple juice and the like with vitamins A, C, D, E, B₁, B₂, and B₆. Kardys, U.S. Pat. No. 3,932,634 discloses a pharmaceutical composition consisting of an oil-soluble vitamin such as vitamin D and water together with a sorbitan monooleate dispersing agent and other oleate dispersing agents.

The addition of vitamin D to beverages such as orange juice calls for a precise measurement of the vitamin to meet the label claim on consumer packages for the Recommended Daily Intake (RDI) per serving, (e.g., about 10% Vitamin D in orange juice). This in turn calls for careful control of the amount of vitamin supplement added to the beverage by not only controlling the process of adding vitamins to the beverage but also analyzing the vitamin content after the addition.

Hill et al., U.S. Pat. No. 5,456,926 and DeWille et al., U.S. Pat. No. 5,597,595 both describe extremely complicated steps for the analysis of vitamin D in beverages. Hill et al., cites the method of Sertl and Molitor, Journal of the Association of Official Analytical Chemists, Volume 68, 2, 177-82 (1985) which consists of saponifying the sample, extracting the saponified sample, subjecting the extract to preliminary liquid chromatography, clean-up, and subjecting the cleaned-up extract to quantitative liquid chromatography. DeWille et al., describe in columns 7-13 an equally complex and time-consuming process for conducting a vitamin D₃ assay.

The foregoing illustrates the difficulty not only in obtaining accurate measurements of vitamin D added to a beverage but also the great amount of time and the need for skilled operators for making such analysis, which would slow down vitamin fortified beverage production and consequently raise production costs.

Accordingly, the present invention is directed to a process for readily determining the quantity of a vitamin, such as an oil soluble vitamin added to a foodstuff, e.g., vitamin D, added to a beverage, or the addition of other vitamins, such as vitamin B, e.g., niacin, niacinamide, B1, B₂, and B₆, which does not involve multiple and complicated steps. The invention avoids a time-consuming process that would slow down production and raise the costs of production of vitamin-fortified foodstuffs such as beverages. The invention also relates to compositions employed in such a process.

### SUMMARY OF THE INVENTION

These and other advantages are realized by the present invention, which comprises a method and a composition of matter, which substantially avoids one or more of the limitations and disadvantages of the related art.

Additional features and advantages of the invention will be set forth in the written description which follows, and in part will be apparent from this description, or may be learned by practice of the invention. The advantages of the invention will be realized and obtained by the process and composition of matter particularly pointed in the written description and claims hereof.

To achieve these and other advantages, and in accordance with the purposes of the invention, as embodied and broadly described, the invention comprises a process and composition for determining the process for readily determining the quantity of a vitamin, such as an oil soluble vitamin, e.g., vitamin D, or the B vitamins, such as niacin, nicinamide, vitamin B₁, B₂, and B₆, added to a foodstuff such as a beverage, which does not involve multiple and complicated steps. The process comprises combining a predetermined amount of a chemical marker and especially a Generally Recognized As Safe (GRAS) chemical marker to a carrier, such as a water dispersible or water-soluble carrier, especially a GRAS carrier in combination with a predetermined amount of a vitamin to obtain a vitamin composition. This vitamin composition is then added to a solid foodstuff or beverage to obtain a vitamin fortified solid foodstuff or beverage followed by quantitatively determining the amount of the chemical marker in the vitamin fortified solid foodstuff or beverage. Correlating the quantitatively determined amount of chemical marker in the solid foodstuff or beverage with the predetermined amount of vitamin in the vitamin composition indicates the amount of vitamin added to the vitamin fortified foodstuff or vitamin fortified beverage.

The composition of matter of the present invention comprises a predetermined amount of a chemical marker, such as a GRAS chemical marker, combined with a composition comprising a carrier, such as a water dispersible or water soluble carrier, such as a GRAS carrier in combination with a predetermined amount of a vitamin.

The vitamins employed according to the invention comprise any of the known vitamins and mixtures thereof, such as the two component, three component or four component mixtures, and especially the oil soluble vitamins, such as vitamin D. The vitamin D of the present invention comprises at least one of vitamin D₁, vitamin D₂, vitamin D₃, vitamin D₄, vitamin D₅, vitamin D₆, and vitamin D₇, (vitamin D₁-D₇), and any art known esters, and any art known reaction products thereof, and mixtures thereof, especially the two component, three component and four component mixtures. These vitamin D compounds include, without limitation, ergosterol, also known as provitamine D₂, ergocalciferol, or vitamin D₂, and cholecalciferol sometimes referred to as activated vitamin D₃. Again all of the foregoing vitamins may be employed as is and as esters and other reaction products of these vitamins as known in the art. Vitamin D₃ and its derivatives are employed in one embodiment of the invention.

Various United States patents disclose vitamin D₃ reaction products which may be used according to the invention, such as U.S. Pat. Nos. 5,817,648; 5,929,056; 6,072,062; 5,075,465; 5,371,249; 5,403,382; 5,389,622; 4,973,721; 5,200,536; 5,210,237; 5,274,142; 5,117,108; 5,278,155; 6,043,386: which are incorporated herein by reference.

Other United States patents describe vitamins D₁-D₇ and their reaction products, which may be used according to the present invention, such as U.S. Pat. Nos. 5,478,816 and 5,422,127. U.S. Pat. No. 5,488,120 describes vitamin D₄ compositions and analogs useful in this invention, whereas the following United States patents also describe various reaction products and derivatives of vitamin D useful in this invention such as U.S. Pat. Nos. 5,587,497; 5,929,056; 6,072,062; 5,880,113; 5,599,958; 5,281,731; 5,750,746; 5,756,783; 5,637,742; 6,025,346; 6,075,015; 6,114,317; 5,240,523; and the like all of which are incorporated herein by reference.

The composition of the invention employs a source of a water dispersible vitamin powder, which is a vitamin in combination with a carrier commercially available from a vitamin supplier. In one embodiment, the carrier comprises a water dispersible or water-soluble carrier, such as maltodextrin (a polysaccharide) combined with a vegetable gum (also a polysaccharide). The carrier may also comprise an edible fat or edible oil known in the art, such as butter fat, or other animal fat, partially hydrogenated or hydrogenated vegetable oil, or vegetable oil, where the vegetable oil comprises corn oil, cotton seed oil, palm oil, canola oil, peanut oil, soy bean oil, or olive oil, rape seed oil, flax oil, sesame oil and the like, and mixtures thereof, such as the one component, two component, three component, or tour component mixtures, and the like. The ratio of vitamin to the carrier is anywhere from slightly less than about 1 to about 99% by weight, or about 1 to about 99% by weight, or about 99 to about 1% by weight, or about 50 to about 50% by weight.

Maltodextrin is a polysaccharide converted to maltose by hydrolysis, produced from the starch material of barley during modification in the manufacture of malt. The composition of maltodextrin depends on the relative amounts of maltose and dextrin in the mixture. Maltose is a malt sugar, glucose-α-glucoside, a dextro disaccharide obtained from malt and starch. Constitutionally, maltodextrin is mid-way between dextrin and maltose. The ratio of maltodextrin or equivalent polysaccharide to the gum can vary anywhere from about 1 to about 99% by weight, or about 99 to about 1% by weight or about 50 to about 50% by weight, although either the maltodextrin and its any art known equivalents may be used alone, or the gum alone can be used as a carrier. When employing the carriers in beverages such as fruit juices and the like, in some instances, it is important to select the carrier so that it does not materially alter the viscosity or taste (including sweetness) of the beverage.

The gum carriers are preferably water-soluble although partially water-soluble or water dispersible gum carriers can be used as well. These gums are natural materials classified as carbohydrate high polymers insoluble in alcohol and other organic solvents, but generally soluble or dispersible in water. Natural gums are hydrophilic polysaccharides composed of monosaccharide units joined by glycoside bonds. They occur as exudations from various trees and shrubs in tropical areas or phycocolloids (algae). Some contain acidic components. Others are neutral. Gums are compounds that can be represented by a formula. They yield sugars on hydrolysis and are the products of disintegration of internal tissues of plant materials.

Common gums useful in the present invention comprise the following:

Arabin-type: completely soluble in water;

Examples include: gum arabic, angico gum, cebil gum, mesquite gum, cedar gum, and Indian gum;

Bassorin type: slightly soluble in water;

Examples include: tragacanth, sterculia, hog gum, amrad gum, and satinwood gum;

Cerasin type: swelling in water;

Examples include: cherry gum, sonora gum, and sassa gum.

Other gums, in addition to the foregoing gums useful in this invention include acacia, ammoniacum, angico, benjamin, benzoin, blue, British, cebil, guar, and kraya gums. Mixtures of the foregoing gums or other equivalent water-soluble or water dispersible carriers can be used in the invention, especially the two component, three component or four component mixtures. Lastly, mixtures of the fat-soluble and/or oil soluble carriers with the water-soluble and/or water dispersible carriers can be used in the invention, especially the two component, three component or four component mixtures. The vitamin premix is unitized, which is to say that it is prepared in a package so that when adding the contents of the package to a fixed quantity of a foodstuff such as a beverage, the overall concentration of the vitamin in the foodstuff such as a beverage so treated will amount to about 10% to about 100% of the Recommended Daily Intake (RDI) per serving. The RDI of vitamin D is 1,000 units, and the unitized vitamin D premix is formulated to fall within the foregoing parameters, especially a premix formulated for addition to a beverage. The amount of vitamin in the unitized premix can vary so that addition of the unitized vitamin premix to the foodstuff will amount to anywhere from about 5 to about 90% of the RDI or about 15 to about 70% of the RDI or about 20 to about 50% of the RDI of the vitamin per serving of the foodstuff such as a beverage.

In selecting the vitamin and the carrier, it is essential to select carriers that will deliver the vitamin so that it will not interfere with bioavailability after consumption. The use of vitamin D₃ and the maltodextrin and gum carrier as described herein provide a bioavailable vitamin D₃ suitable for fortifying beverages such as orange juice, especially orange juice fortified with calcium.

Maltodextrin is a free flowing agent suitable as a carrier in the present invention and acts as a bulking agent and is used generally in amounts of about ½ pound per 1,000 gallons of beverage and has the advantage of not adding any sweetness to the beverage and the additional advantage of having no taste. The polysaccharides used according to the invention are selected to have these properties as well as the quality of not significantly altering the viscosity of the beverage.

The chemical markers employed according to the method and composition of the invention comprises any GRAS material easily tested to qualitatively determine the type of marker, and quantitatively determine the amount of marker added to the beverage. Examples of these markers include vitamin C, GRAS calcium salts, GRAS colorants or food grade dyes. Vitamin C can be qualitatively and quantitatively analyzed by spectrophotometric titration, calcium by specific ion electrodes or atomic absorption and GRAS colorants or food dyes by spectrophotometric means or color chips. Additionally, GRAS sodium or potassium salts can be employed as chemical markers, qualitatively and quantitatively analyzed by atomic absorption.

In those beverages which also contain vitamin C, or calcium salts, colorants, food grade dyes or sodium or potassium salts or other chemical markers, the invention requires analyzing the beverage prior to the addition of the vitamin premix and subsequent to the addition of the vitamin premix so that any of these chemical markers or elements present in the beverage before the addition can be subtracted from the results obtained after the addition of the vitamin premix.

The quantitative analysis of the chemical marker (corrected for any identical compound in the beverage prior to adding the vitamin premix) will indicate the amount vitamin added to the beverage.

The vitamin premix is added to a foodstuff such as a beverage including water, mineral water, truit juices, truit drinks and truit flavors such as citrus juices and citrus drinks including orange, lemon, lime, tangerine, mandarins, grapefruit, grape, pear, passion fruit, pineapple, banana, banana puree, apple, cranberry, cherry, raspberry, peach, plum, grape, currant, cranberry, blackberry, blueberry, strawberry, mirabelle, watermelon, honeydew, cantaloupe, mango, papaya, botanical flavors such as flavors derived from cola, tea, coffee, chocolate, vanilla, almond, vegetable juices, vegetable drinks, and flavors such as tomato, cabbage, celery, cucumber, spinach, carrot, lettuce, watercress, dandelion, rhubarb, beet, cocona, guava, han guo, as well as milk obtained from mammals, and artificial milk products, including both liquid and dry milk products, and mixtures thereof, such as the two component, three component and four component mixtures. The terms “juice” and “drink” as used herein have the meaning ascribed to them by a person with ordinary skill in the art, and includes a concentrate of a juice or drink, where the term “concentrate” also has the meaning ascribed to it by a person with ordinary skill in the art.

The process and composition of the invention can also be used with typical sport beverages whether as a product requiring the addition of water or in admixture with water. These beverages contain sucrose syrup, glucose-fructose syrup, citric acid, sodium citrate, monopotassium phosphate and other materials for replenishing electrolytes lost during perspiration. The process and composition of the invention can also be used in combination with any food product that would benefit from a production method that provided a simple and fast determination of the amount of vitamin D added during manufacture. Additionally, the process and composition of the invention can employ any fat-soluble vitamin including vitamins A, E and K, any art known derivatives thereof and combinations thereof as well as other vitamins known in the art.

### EXAMPLE

The following composition was prepared for addition to orange juice. A water dispersible or soluble vitamin D powder using maltodextrin and gum as carriers is prepared as a premix using a predetermined amount of Vitamin D₃ in combination with a predetermined amount of the carrier.

Vitamin D₃ Premix

The vitamin D₃ premix is purchased from the manufacturer in standard lots and is directly suitable for addition to a foodstuff, such as juices or juice concentrates during processing.

Ascorbic Acid

Ascorbic acid (vitamin C) meeting food grade specifications of the Food Chemicals Codex (FCC, 1996) is used as an antioxidant in the vitamin D₃ premix.

Maltodextrin

Maltodextrin meeting food grade specifications of the Food Chemicals Codex (FCC, 1996) is used as a carrier in the vitamin D₃premix.

dl-α-Tocopherol

dl-α-Tocopherol (vitamin E) meeting food grade specifications of the Food Chemicals Codex (FCC, 1996) is used as an antioxidant in the vitamin D₃ premix.

Dry Vitamin D₃, Type 100 CWS/A (cold water formulation of vitamin D₃) Dry Vitamin D₃, Type 100 CWS/A is certified by the manufacturer to meet the Pharmacopoeia Europe requirements for vitamin D₃ purity (irradiation by-products) and content (between 90 to 110% of labeled amount) (100,000 IU/g, 2.5 mg/g). The cold water soluble formulation contains the following ingredients:

Sucrose, 35 to 40%

Acacia gum, 35 to 40%

Corn starch modified, 15 to 20%

Soy oil, 5 to 10%

dl-α-Tocopherol, <1%

Crystalline vitamin D₃, <1%

All ingredients are appropriate for use in food and equivalent to food grade materials (FCC, 1996).

Manufacturing Process

The manufacturing process for dry mix production is highly standardized and certified under the ISO 9001 standard. The process control system identifies ingredients by code number, lot number and quantity for specific batches. All ingredients are delivered to the blender and blender times identified from the master recipe. Prior to packaging the dry blended mix passes through a scalping screen (16 mesh) and rare earth magnet. Following packaging samples are taken for quality control analysis. Packages are only released when they meet specifications.

Product Specifications and Analysis

Premix Specifications

| Specification Parameter | Specification | Analysis Method |
|---|---|---|
| Physical Properties | Free flowing powder, | |
| | passes through 16 mesh | |
| | U.S. standard sieve | |
| Ascorbic acid | Between 12 and 13.2 mg | Iodine titration |
| | per 16.5 g premix | |
| Vitamin D₃ | Between 120 and 156 IU | Modified AOAC |
| | per 16.5 g premix | 982.29 |

Product Analysis

Four manufactured lots of the vitamin D₃ premix were analyzed to indicate that manufacturing process produces a consistent product in terms of its chemical composition.

| | |
|---|---|
| Specification | Manufacturing Lots |

| Parameter | SR 10587 | SR-10641 | SR-10763 | SR-10764 |
|---|---|---|---|---|
| Physical | Conforms | Conforms | Conforms | Conforms |
| properties | | | | |
| Ascorbic acid | 12.5 | 12.5 | 12.8 | 12.7 |
| (mg/16.5 g | | | | |
| premix) | | | | |
| Vitamin D₃ | 127 | 126 | 136 | 124 |
| (IU/16.5 premix) | | | | |

Vitamin D₃ Fortified Juice

Raw Material Specifications

Juice Concentrates

All juice concentrates meet USDA standards for agricultural commodity products.

Calcium Salts (Calcium Lactate, Calcium Phosphate, Calcium Citrate, Calcium Fumarate)

All the calcium salts meet the food grade specifications of the Food Chemicals Codex (FCC, 1996).

Manufacturing Process

The calcium sources used are individual or different combinations of 2 or more calcium salts to provide 350 mg total calcium per 240 mL serving of juice. Calcium salts are generally added to a stainless steel blending tank with sufficient filtered water to prepare a slurry and are agitated until totally dispersed. This slurry is pumped into a batch tank with additional filtered water. Juice concentrates and cool (35° F. to 38° F.) treated water are added to bring the product close to but less than the final volume as determined by soluble solids content measured in ° Brix. A sample of the calcium-enriched juice is taken for initial vitamin C analysis.

The content of one Vitamin D₃ premix pouch (264 g) is added to the batch for every 1,000 gallons of product (via dispersion in a small quantity of treated water). A record is made of the number of units of premix added (sticker or bar code) to the batch sheet. Samples of before and after premix addition are analyzed for vitamin C content to verify that the marker vitamin C is within the specified range. A difference between before and after premix additions must approximate 5 mg/100 mL finished juice (before addition 3 mg/100 mL juice; after addition 8 mg/100 mL juice). The batch is adjusted and reanalyzed, if necessary. When the target specifications are achieved the batch is released for subsequent processing steps.

Flash pasteurization is accomplished by heating as rapidly as possible in a tubular or plate heat exchanger. The product is chilled immediately and packed into sanitized cartons, or plastic packages. The product is immediately moved to cold storage facilities following case packing and palletizing.

Finished product and juice is shipped at temperatures maintained between 32° F. and 45° F.

Manufacturing Controls

Because vitamin D₃ is fat-soluble it was necessary to demonstrate that the vitamin was dispersed uniformly throughout the juice product. The vitamin D₃ dry premix was blended into 200 gallons of single strength juice at the recommended rate. Following 10 minutes of agitation, the vitamin D3 concentration of a sample from the blend tank was 121 IU/serving. The product was pasteurized and re-sampled at the filler from different sites of the batch. Vitamin D₃ levels were 116 and 117 IU/serving, respectively. The agitation was stopped for 30 minutes and the batch re-sampled at the filler; vitamin D₃ levels were 119 IU/serving. The agitation was continued for another 10 minutes and the batch re-sampled. Vitamin D₃ levels at the filler were 120 IU/serving. A final sample from the filler contained 123 IU vitamin D₃/serving. The results showed identical concentrations of vitamin D₃, confirming that the vitamin D₃ remains dispersed under normal production conditions. Following solubilization, vitamin D3 likely becomes associated with the fat-soluble coloring and flavoring materials that are evenly dispersed throughout the product.

Vitamin D is difficult to analyze in a production plant quality assurance laboratory requiring methods be developed to assure that the proper amount of vitamin D₃ is added to fortified juices and that the vitamin D₃ is stable in these products.

Stability

Different factors such as temperature, light, oxygen, pH, vitamin C and packaging materials may effect vitamin D stability. Several of the above parameters were studied in fortified juice and juice beverage products containing calcium to deliver 350 mg of total calcium per 240 mL serving for up to 8 weeks, the current shelf life for juice products. The packaging materials studied included glass, composite paperboard (gable-top carton), and high-density polyethylene (HDPE) plastic typical of product containers currently sold. Although the routine analysis method for vitamin D₃ can separate vitamin D₃ from 5,6-trans-vitamin D₃, 5,6-trans-vitamin D₃ was not routinely analyzed in all the stability samples. The formation of 5,6-trans-vitamin D₃ was specifically analyzed in some specific samples since it has been reported that it may be formed under acidic conditions.

Levels of vitamin D₃ in calcium fortified orange juice (120 IU/serving, 1.25 μg/100 mL) or calcium fortified lemonade were unaffected by storage at typical storage temperatures of 45° F. or abuse storage temperatures of 75° F. for up to 8 weeks. Specific analysis of samples of calcium fortified orange juice and calcium-fortified lemonade for 5,6-trans-vitamin D₃ stored at 75° F. for 8 weeks indicated that 5,6-trans-vitamin D₃ was not formed. Vitamin D₃ levels in calcium fortified juice stored at 45° F. and continuously exposed to fluorescent light (clear bottle) were unaffected for up to 8 weeks.

In another embodiment, the premix has a known quantity of a chemical marker comprising vitamin C added to it, and is unitized, i.e., placed in a standard package for addition to a 1,000 gallon batch of orange juice fortified with calcium.

The unitized vitamin D premix is dispersed in water and then added to the orange juice. The quality check on vitamin D addition is based on a calculation of vitamin C in the unitized pre-mix and the presence of vitamin C in the product batch. For products with intrinsic vitamin C content, i.e., orange juice, the increased vitamin C level would be observed to verify not only the premix as actually added but also the quantity of vitamin D₃ added to the orange juice.

By employing the method of the invention, analyzing for vitamin D₃ is provided by analyzing for added vitamin C. The quantity of chemical marker, vitamin C, indicates the amount of vitamin D₃ added to the batch.

The process of the invention also takes into account that the various ingredients of the premix added to the foodstuff as well as the foodstuff could change after the addition, even though the ingredients retain their characteristics as bioavailable nutrients and vitamins. Accordingly, the invention also relates to a product made by the process of the invention.

The various numerical ranges describing the invention as set forth throughout the specification also include any combination of the lower ends of the ranges with higher ends of the ranges set forth herein, or any single experimental value or other single value set forth herein that will extend or reduce the scope of the lower limits of the range, or the higher limits of the range, where the range includes, inter alia, ranges of concentrations of compounds, ratios of these compounds to one another and the like, as well as all whole number and/or fractional number values encompassed by these ranges, and ranges encompassed within these ranges. The term “about” as it applies to individual numerical values, or numerical values stated in the ranges of the present specification means slight variations in these values. It is also intended that the term “substantial” or the term “substantially” can be substituted for the term “about” as used in this specification, where “substantial” and “substantially” mean either that which is entirely specified or for the most part specified. Any reference to a United States patent, and other printed publication set forth in the written description is incorporated in the written description by reference. All quantities of materials expressed in percentages are percentages by weight, unless otherwise indicated. The term “foodstuff” as used in the present specification includes both solid foodstuffs and beverages.

The principles, various embodiments, and modes of operation of the present invention have been described in the foregoing written description. The invention, which is intended to be protected here, however, is to be construed as including variations and changes that may be made by those skilled in the art without departing from the spirit of the invention.

1-27. (Canceled).

28. A process for determining the quantity of a vitamin added to a foodstuff comprising:
(a) combining a predetermined amount of vitamin C as a chemical marker with a composition comprising a carrier in combination with a predetermined amount of vitamin to obtain a vitamin composition;
(b) adding said vitamin composition to a foodstuff to obtain a vitamin-fortified foodstuff;
(c) quantitatively determining the amount of said vitamin C as a chemical marker in said vitamin fortified foodstuff; and
(d) correlating the quantitatively determined amount of said Vitamin C as a chemical marker in said vitamin fortified foodstuff with said predetermined amount of vitamin in said vitamin composition.

29. The process of claim 28 for determining the quantity of vitamin D added to a foodstuff comprising:
(a) combining a predetermined amount of vitamin C as a chemical marker with a composition comprising a water dispersible or water-soluble carrier in combination with a predetermined amount of vitamin D to obtain a vitamin D composition;
(b) adding said vitamin D composition to a foodstuff which is a beverage to obtain a vitamin D fortified beverage;
(c) quantitatively determining the amount of said vitamin C as a chemical marker in said vitamin D beverage; and
(d) correlating the quantitatively determined amount of said vitamin C as a chemical marker in said vitamin D fortified beverage with said predetermined amount of vitamin D in said vitamin D composition.

30. The process of claim 29 wherein said vitamin D comprises vitamin D₃.

31. The process of claim 30 wherein said carrier comprises a polysaccharide.

32. The process of claim 31 wherein said carrier comprises a combination of maltodextrin and a vegetable gum.

33. The process of claim 28 wherein said foodstuff is a fruit juice or a fruit drink beverage.

34. The process of claim 33 wherein said foodstuff is a citrus beverage.

35. The process of claim 34 wherein said foodstuff is an orange, grapefruit, lemon or lime beverage.

36. The process of claim 29 wherein said foodstuff comprises a beverage fortified with calcium.

37. The process of claim 33 wherein said foodstuff is fortified with calcium.

38. The process of claim 34 wherein said foodstuff is fortified with calcium.

39. A product produced by the process of claim 32.

40. A product produced by the process of claim 28, wherein said carrier comprises a combination of maltodextrin and a vegetable gum, and wherein said foodstuff is a fruit juice or a fruit drink beverage.

41. A product produced by the process of claim 28, wherein said carrier comprises a combination of maltodextrin and a vegetable gum, and wherein said foodstuff is a citrus beverage.

42. A product produced by the process of claim 28, wherein said carrier comprises a combination of maltodextrin and a vegetable gum, and wherein said foodstuff is a calcium fortified beverage.

43. A product produced by the process of claim 28, wherein said carrier comprises a combination of maltodextrin and a vegetable gum, and wherein said foodstuff is a calcium fortified fruit juice or fruit drink beverage.

44. A product produced by the process of claim 28, wherein said carrier comprises a combination of maltodextrin and a vegetable gum, and wherein said foodstuff is a calcium fortified citrus beverage.

45. A composition for addition to a foodstuff comprising a predetermined amount of vitamin C as a chemical marker combined with a composition comprising a carrier in combination with a predetermined amount of a vitamin, wherein said carrier comprises a combination of maltodextrin and a vegetable gum.

46. The composition of claim 45 wherein said vitamin comprises vitamin D.

47. The composition of claim 46 wherein said vitamin D comprises vitamin D₃.

48. A process for determining the quantity of a vitamin added to a foodstuff comprising:
(a) combining a predetermined amount of vitamin C as a chemical marker with a composition comprising a carrier in combination with a predetermined amount of vitamin to obtain a vitamin composition;
(b) adding said vitamin composition to a foodstuff to obtain a vitamin-fortified foodstuff;
(c) quantitatively determining the amount of said vitamin C as a chemical marker in said vitamin fortified foodstuff;
(d) correlating the quantitatively determined amount of said Vitamin C as a chemical marker in said vitamin fortified foodstuff with said predetermined amount of vitamin in said vitamin composition; and
(e) adding calcium to said foodstuff in an amount effective to fortify said foodstuff.

49. A composition for addition to a foodstuff comprising:
a predetermined amount of vitamin C as a chemical marker combined with a water dispersible or water-soluble carrier in combination with a predetermined amount of a vitamin; and
calcium in an amount effective to fortify said foodstuff.

50. The composition of claim 49 wherein said carrier comprises a combination of maltodextrin and a vegetable gum.

51. The composition of claim 49 wherein said vitamin consists essentially of vitamin D.

52. A beverage comprising:
water;
a combination of a predetermined amount of vitamin C, a water dispersible or water-soluble carrier, and a predetermined amount of a vitamin; and
calcium in an amount effective to fortify said beverage.

53. The beverage of claim 52 wherein said vitamin consists essentially of vitamin D.

54. The beverage of claim 52 wherein beverage consists essentially of a calcium fortified fruit juice or fruit drink beverage.
